(19) United States
(12) Patent Application Publication
(10) Pub. No.: US 2026/0043332 A1
(43) Pub. Date: Feb. 12, 2026

(54) THRUST RINGS, PROPELLERS AND METHODS

(71) Applicant: Sharrow Engineering LLC, Shelby Township, MI (US)

(72) Inventors: Gregory Charles Sharrow, Grosse Pointe Park, MI (US); Anthony D. Sacksteder, Bala Cynwyd, PA (US)

(73) Assignee: Sharrow Engineering LLC, Shelby Township, MI (US)

(21) Appl. No.: 18/947,464

(22) Filed: Nov. 14, 2024

Related U.S. Application Data
(60) Provisional application No. 63/598,758, filed on Nov. 14, 2023.

(51) Int. Cl. F01D 5/02; B63H 1/20; B64C 11/04

(52) U.S. Cl. CPC F01D 5/02; B63H 1/20; B64C 11/04

(57) ABSTRACT

Disclosed propeller assemblies can include thrust rings that are individually selectable for tuning of propeller drive performance, each one of the plurality of thrust rings can be configured for connection with the propeller hub of the propeller drive assembly as an aftward extension from the propeller hub for configuring thrust forces generated under operation of the propeller drive assembly.

### CROSS-REFERENCE

This utility application claims the benefit of priority to U.S. provisional patent application No. 63/598,758, filed on Nov. 14, 2023, entitled “THRUST RINGS, PROPELLERS AND METHODS,” the contents of which are hereby incorporated by reference in their entirety.

### FIELD

The present disclosure concerns propellers that may be used, for example, in motive propulsion for aircraft, watercraft, turbines, unmanned aerial vehicles, and/or in fluid circulation.

### SUMMARY

According to an aspect of the present disclosure, a propeller assembly may include a propeller drive assembly including a propeller hub, and at least one blade engaged with the hub and projecting radially outward therefrom. The at least one blade may define a looped-shape. The propeller hub may be adapted for driven rotation to rotate the at least one blade to generate fluid thrust. The propeller assembly may include a thrust ring kit which may include a plurality of thrust rings, each thrust ring may be individually selectable for tuning of propeller drive performance. Each one of the plurality of thrust rings may be configured for connection with the propeller hub of the propeller drive assembly as an aftward extension from the propeller hub for configuring thrust forces generated under operation of the propeller drive assembly. Each of the plurality of thrust rings may be defined with a different combination of axial length, maximum outer diameter, and flair radius defining a unique effective pitch increase and/or slip value compared with the propeller drive assembly alone. The different combinations may include only one of axial length, maximum outer diameter, and flair radius being different.

In some embodiments, the thrust rings may vary relative to one another in axial length. The thrust rings may vary relative to one another in flare radius. The thrust rings may be configured to provide different performance characteristics.

In some embodiments, each thrust ring may be attachable to ribs within the propeller hub. Each thrust ring may be configured to account for additional weight and/or material of ribs of increase length. At least one of the plurality of thrust rings may have a flared aft portion with maximum outer diameter within the range from 90% to 125% of the outer diameter of the hub.

In some embodiments, the maximum outer diameter of the flared aft portion of the at least one thrust ring may be within the range from 100% to 125% of the outer diameter of hub. At least one of the plurality of thrust rings may have a flared aft portion. The maximum outer diameter of the flared aft portion is within the range from 1% to 50% of the length of the hub. The maximum outer diameter of the flared aft portion may be within the range from 10% to 40% of the length of the hub. The maximum outer diameter of the flared aft portion may be within the range from 15% to 35% of the length of the hub.

In some embodiments, an axial length of at least one of the thrust rings may be within the range from 5% to 25% of the outer diameter of the hub. The axial length may be within the range from 10% to 15% of the outer diameter of the hub. At least one of the thrust rings may configured to modify RPM within the range from −350 to 100 to increase effective pitch by an amount within the range from 1″ to 3″.

At least one of the thrust rings may be configured to modify RPM within the range from −400 to 150 to increase effective pitch by an amount within the range from 1″ to 5″. The thrust rings may be configured to be attachable to a loop-propeller.

According to another aspect of the present disclosure, a method of forming a propeller assembly may include providing a propeller having a propeller hub; selecting a pitch amount; and providing a thrust ring to produce the pitch amount for the propeller. The pitch amount may include an effective pitch amount.

In some embodiments, providing the thrust ring may include selecting a thrust ring from a thrust ring kit comprising a plurality of thrust rings, each thrust ring individually selectable for tuning of propeller drive performance. Each one of the plurality of thrust rings may be configured for connection with the propeller hub of the propeller drive assembly as an aftward extension from the propeller hub for configuring thrust forces generated under operation of the propeller drive assembly. Each of the plurality of thrust rings may be defined with a different combination of axial length, maximum outer diameter, and flair radius defining a unique effective pitch increase and/or slip value than without the thrust ring.

### DESCRIPTION OF THE DRAWINGS

The patent or application file contains at least one drawing executed in color. Copies of this patent or patent application publication with color drawing(s) will be provided by the Office upon request and payment of the necessary fee. For further detail regarding illustrative embodiments of the disclosed aspects, reference is made to the detailed description provided below, in conjunction with the following illustrations:

FIG. 1 depicts an illustrative hub with a range of interchangeable thrust rings.

FIG. 2A depicts a thrust ring on a hub viewed from the aft end of the hub. FIG. 2B is a cross-section taken through line A-A of FIG. 2A. FIG. 2C depicts a lateral cross-sectional view of an extension ring, and FIGS. 2D-2F depict lateral cross-sectional views of thrust rings.

FIGS. 3A-C depict views of a thrust ring with an extension thrust ring.

FIG. 4 is another illustration of a thrust ring attached to a hub wherein a hub rib is extended to the thrust ring.

FIGS. 5A-B depict the end of a hub showing an internal rib with an extended part.

FIG. 6 depicts a cross section of a thrust ring connected to a hub at its outer hub.

FIG. 7 is a close up of a thrust ring having an attachment opening.

FIGS. 8A-C depict cross sectional views of a propeller attached to an engine wherein the propeller has a thrust ring with an extension.

FIGS. 9A-C depict cross sectional views of a propeller attached to an engine wherein the propeller has a thrust ring attached to an extension.

FIGS. 10A-B depict an illustrative inwardly flared thrust ring on a propeller.

FIGS. 11A-E depict an illustrative closed thrust ring.

FIG. 12 is a cross-sectional view of a propeller with a thrust ring attached.

FIG. 13 is a schematic of a hub with modular thrust rings and a close up of a connection mechanism to attach a thrust ring to a hub.

FIG. 14 is a chart depicting a relationship of thrust ring selection to propeller performance.

FIGS. 15A&B and 16A&B are respective color (A) and non-color (B) partial elevation views of a propeller having no thrust ring in FIGS. 15A&B, and having a thrust ring in FIGS. 16A&B for comparison to illustrate the pressure regions.

FIGS. 17A&B and 18A&B are respective color and non-color partial perspective views of the propeller having no thrust ring in FIGS. 17A&B, and having a thrust ring in FIGS. 18A&B for comparison to illustrate the pressure regions.

FIGS. 19A&B and 20A&B are respective color and non-color partial perspective views, similar to FIGS. 17A&B and 18A&B, of the propeller having no thrust ring in FIGS. 19A&B, and having a thrust ring in FIGS. 20A&B for comparison to illustrate the pressure regions.

### DETAILED DESCRIPTION

Disclosed are thrust rings, propellers with thrust rings and methods for improving and optimizing propeller performance. The thrust rings can be an integral part of a propeller hub or a separate component attached to a compatible propeller hub.

The thrust rings are configured to build increased pressure on the thrust ring and pressure side of the propeller blades during operation of the propeller. Changes to the thrust ring structure modifies the effective propeller blade pitch. Thus, the effective pitch is changed without modification to the propeller blades. Wherein “pitch” is defined as the theoretical distance a propeller would advance during one revolution. The actual distance a marine vessel or aircraft moves forward for one full revolution of the propeller is less than the pitch. This “slip” is varied by the thrust ring configuration.

The hydrodynamic effect of the thrust ring is to increase pressures in the region of the aft hub end, affecting the most aftward (outlet) regions of the propeller's blades, whereupon the pressure faces will generate more thrust. Concurrently, the increased pressure due to the thrust ring interaction may have less of an effect on the suction faces, particularly if those regions are partially or fully cavitating. Such an increase in pressure may reduce cavitation, thereby increasing thrust. The net effect is an increase in total blade loading, allowing the propeller to produce the same thrust at a lower RPM, which mimics an increase in pitch number.

Outboard propellers are produced with a range of hub styles. A common configuration consists of a hollow outer hub connected to the inner hub via spoke-like ribs. The inner hub provides the interface to the motor drive shaft. The space between the inner and outer hubs provides a volume through which engine exhaust gases are channeled. The thrust rings form a portion of the hub, aft of the attachment point of the blade. The thrust rings can provide several functional attributes. The thrust ring is generally a ring with a flared or bell shaped section profile. The form of the thrust ring can make a significant difference in how the propeller, motor and vehicle to which it is attached, such as a boat, performs as a system.

The thrust rings affect fluid flow, thereby modifying engine performance. The thrust ring's axial length and amount of outward flare can induce a change in exhaust flow and alter engine performance. The thrust ring design can also alter the total drag of the propeller which affects speed, efficiency and other performance metrics, such as the speed at which the hull achieved planing. The thrust ring design can also change the effective nonaxial forces produced by the rotation and axial angle of the propeller relative to incoming flow of the propeller. This force is referred to as stern lift if the force is upwards (raising the stern) or bow lift if the force is downward (raising the bow).

Further disclosed is a modular system of thrust rings that can be attached to a propeller. Unlike other propeller modification devices, the thrust rings in the system attach to the aft end of the propeller hub. The thrust rings may alter the flow of exhaust gases and fluid through the propeller to achieve desired performance characteristics. The technological advance is a single propeller that is readily modified, with each modified version exhibiting different properties. In illustrative instances, the propeller can be modified without removing the propeller from an engine.

Further disclosed is a propeller having any one of the thrust rings shown in the figures of the modular system.

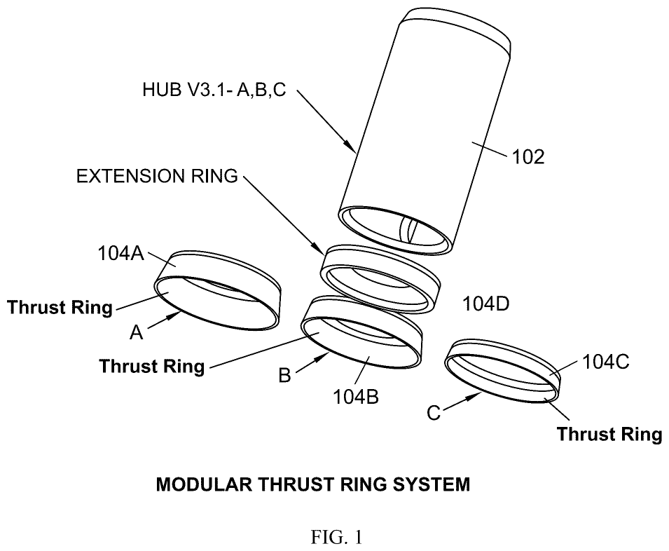

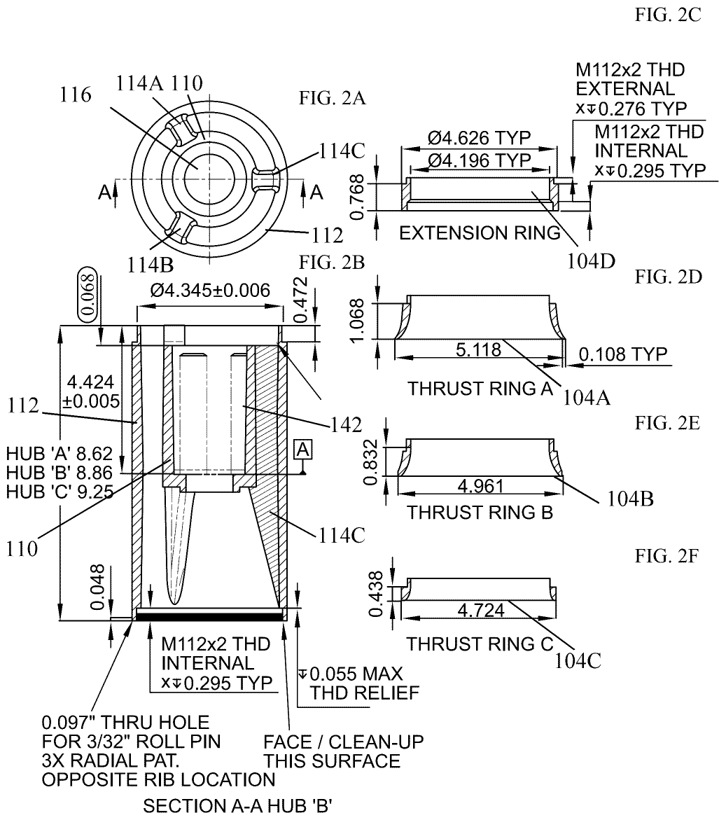

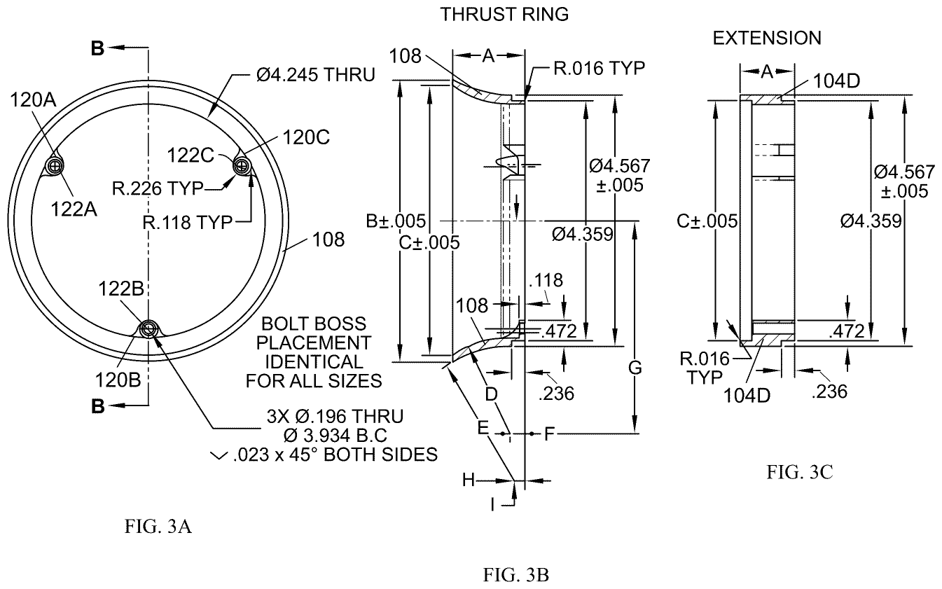

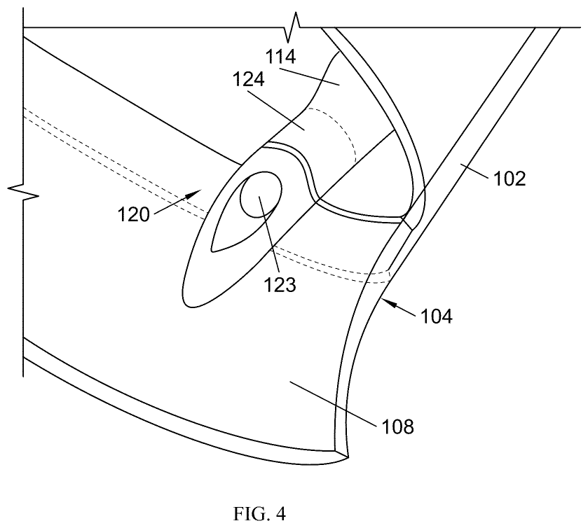

FIG. 1 depicts an illustrative hub 102 with a range of interchangeable thrust rings 104A-D. In an illustrative embodiment, two or more thrust rings are supplied, each with a mechanism to attach it to a single propeller. The thrust rings are in the form of a ring having an aft portion 108 (see FIGS. 3 and 4) that is either flared outwardly flared, inwardly flared, or cylindrical (straight). Cross sections of illustrative rings 104A-D are shown in FIG. 2.

FIG. 2A depicts a thrust ring 104 on a hub 102 viewed from the aft end of the hub 102. FIG. 2B is a cross-section taken through line A-A of FIG. 2A. Thrust ring 104 has an outwardly flared aft portion 108. Hub 102 has an inner hub 110 and an outer hub 112. Inner hub 110 is attached to outer hub 112 by ribs 114A-C. Inner hub 110 has a through hole 116. Propeller blades are attached to outer hub 112. A space 118 exists between inner hub 110 and out hub 112 through which engine exhaust gases are channeled. In this illustrative embodiment, ribs 114A-C extend to the aft end of hub 102. Section A-A is taken through rib 114C as can be seen in FIG. 2B. Thrust ring 104 is attached to ribs 114A-C.

Each thrust ring 104 has a particular axial length, outer diameter and radius of flare, the combination of which can achieve desired performance characteristics. The cylindrical thrust ring 104, which increases the axial length of the hub with no change in diameter, may be used alone or in conjunction with a flared thrust ring 104 to provide a longer and flared hub end.

In an illustrative embodiment, the axial length of thrust ring 104 is 5%-25% of the outer diameter of hub 102. In a further illustrative embodiment, the axial length of thrust ring 104 is 10%-15% of the outer diameter of hub 102. In some embodiments, the axial length of thrust ring 104 is 10%-15% of the axial length of hub 102

In an illustrative embodiment, the outer diameter of the flared aft portion 108 of thrust ring 104 is 90%-120% of the outer diameter of hub 102. In a further illustrative embodiment, the outer diameter of the flared aft portion 108 of thrust ring 104 is 100%-115% of the outer diameter of hub 102, for non-limiting example, with a outer diameter of hub 102 set as 100 mm, the outer diameter the flared aft portion 108 of thrust ring 104 may be 100-115 mm, for example, 110 mm.

In an illustrative embodiment, the outer diameter of the flared aft portion 108 of thrust ring 104 is 1%-50% of the length of hub 102. In a further illustrative embodiment, the outer diameter of the flared aft portion 108 of thrust ring 104 is 10%-40% of the length of hub 102. In a further illustrative embodiment, the outer diameter of the flared aft portion 108 of thrust ring 104 is 15%-35% of the length of hub 102.

In an illustrative embodiment, the outer diameter of the flared aft portion 108 of thrust ring 104 is in the range of 5%-30% greater than the outer diameter of hub 102. In a further illustrative embodiment, the outer diameter of the flared aft portion 108 of thrust ring 104 is in the range of 10%-25% greater than the outer diameter of hub 102.

Thrust rings and propellers can have one or more of the above-stated ranges. In a system that comprises multiple thrust rings, at least one of the thrust rings may have any one or more of the parameters noted above.

The following chart provided illustrative parameters and the corresponding changes to effective pitch.

| | THRUST RING SIZE & INFLUENCE FACTOR as | | | | | | |
|---|---|---|---|---|---|---|---|
| | % of HUB DIMENSIONS | | | | | | |
| | | | | TR Max | | PERFORMANCE | |
| | | | TR axial | OD % | TR Flair | EFFECT | |
| INFLUENCE | Thrust | | len. as | Incr | Radius | | Apparent |
| FACTOR | Ring | Hub | % of | of Hub | as % of | RPMp | Pitch |
| Len*OD/R | Type | len (″) | Hub Len | Diam | Hub Diam | Decrease | Change |
| 0.0 | 0 -ext. | 9.25 | 3% | — | — | 0 | |
| | Straight | | | | | | |
| 4.6 | C-Small | 9.25 | 5% | 2% | 21% | −125 | +1.3″ |
| 9.3 | B- | 8.86 | 9% | 7% | 38% | −250 | +2.1″ |
| | Medium | | | | | | |
| 11.3 | A-Large | 8.62 | 12% | 11% | 43% | −320 | +3.0″ |

In an illustrative embodiment, a thrust ring modifies RPM in the range of −320 to 125 and increases effective pitch by 1.3″ to 3″. In a further illustrative embodiment, a thrust ring modifies RPM in the range of −400 to 150 and increases effective pitch by 1″ to 5″.

The thrust rings may be attached to the hub by various means, provided they are detachable and compatible with the operation of the propeller. The attachment mechanism should provide a secure connection that withstands operation of the propeller.

As shown in FIGS. 2, 4, 5 and 6, hub 102 has ribs 114 to which thrust rings 104 can be attached. Conventional hubs include ribs that attach inner hub 110 to outer hub 112. Traditionally, the rib length is optimized to create a strong enough connection between inner hub 110 and outer hub 112, without adding unnecessary weight or contours that could negatively affect fluid flow. Thus, it is counter to conventional hub design to provide ribs of a length longer than necessary to adequately secure inner hub 110 to outer hub 112. In illustrative embodiments, the negative performance attributable to additional weight is compensated for by one or more of the following: the thrust ring axial length, flare direction (inward or outward), outer diameter, radius of flare. In a particular embodiment, flare radius and axial length are used to optimize performance and counter the additional rib length.

For loop propellers, such as those marketed by Sharrow Marine, hub lengths may need to be longer because the blades span a greater axial distance. Rib lengths may therefore need to be longer. A thrust ring can be configured to optimize performance in light of the additional length and material. The propellers, systems and methods described herein include those embodying or applied to loop propellers. The loop propellers may have any number of blades. In an illustrated embodiment, the number of blades is between 2 and 8.

Illustrative attachment mechanisms include:

Thread-on thrust rings, such as threads with a fine pitch male thread and mating female thread in the propeller outer hub ID, may be used for example. This is depicted in FIGS. 2A-B.

Bayonet type mounting: analogous to a camera lens attachment method in which a locking tab engages with an annular slot requiring a partial turn to fasten. A marked section of the thrust ring is aligned with a marked section of the hub or an extension of the hub. Once aligned and coupled, the thrust ring is twisted until it locks in place.

Cross Pinned: In which a through pin or screw is inserted perpendicular to the prop axis into a drilled through hole and connects the annular lap joint of the Propeller hub to that of the thrust ring

Set Screw: The setscrew attachment is similar to the cross pinned attachment, but uses a threaded screw instead of a pin to facilitate easier removal.

For more permanent attachments, glue bonding, shrink-fitting, staking or spot welding may be used. For some applications, these types of attachments may provide a needed level of strength, but may also require additional effort to change to other thrust rings as compared to the “quicker release” types of attachments.

FIGS. 3A-C depict views of a thrust ring 104 with an extension thrust ring 104D. The term “extension thrust ring” is used herein for an interchangeable ring in cylindrical form that may or may not have diffusing abilities. FIG. 3A is an aft view of thrust ring 104. It shows attachment openings 120A-C through which bolts 122A-C can be inserted to attach thrust ring 104 to hub 102 directly, or first through extension thrust ring 104D before being secured to hub 102. Bolts 122A-C attach to ribs 114A-C. FIG. 3B is a cross-section taken though line B-B of FIG. 3A and shows thrust ring 104. FIG. 3B depicts a cross section of extension thrust ring 104D.

FIG. 4 is another illustration of a thrust ring 104 attached to hub 102. Rib 114 is extended to thrust ring 104. The extended part may be cylindrical as shown by extended part 124. Extended part 124 accommodates screw 123 through attachment opening 120.

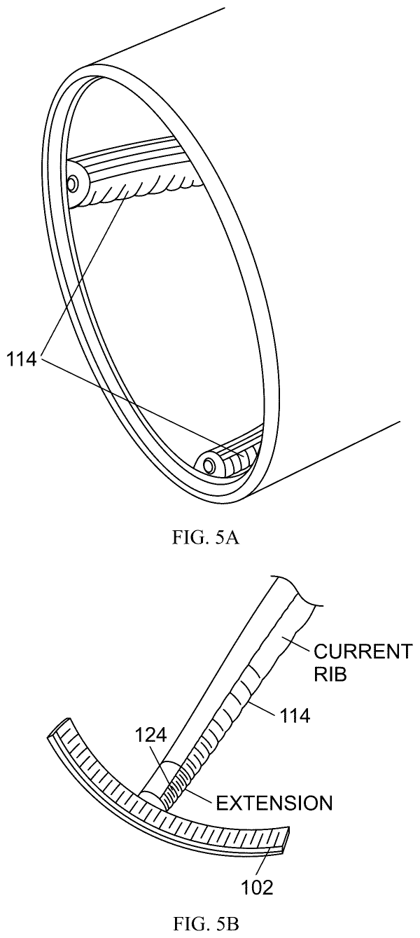

FIGS. 5A-B depict the end of hub 102 showing ribs 114 and a cross section of rib 114 and extended part 124.

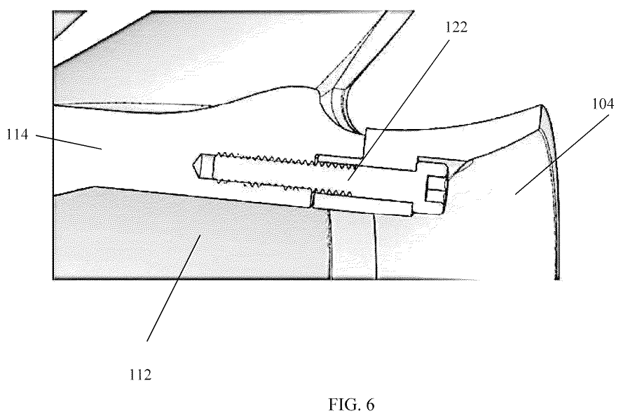

FIG. 6 depicts a cross section of a thrust ring 104 connected to a hub 102 at its outer hub 112. A bolt or screw extends through an opening in thrust ring 104 and into rib 114 where it is secured, thereby attaching thrust ring 104 to hub 102.

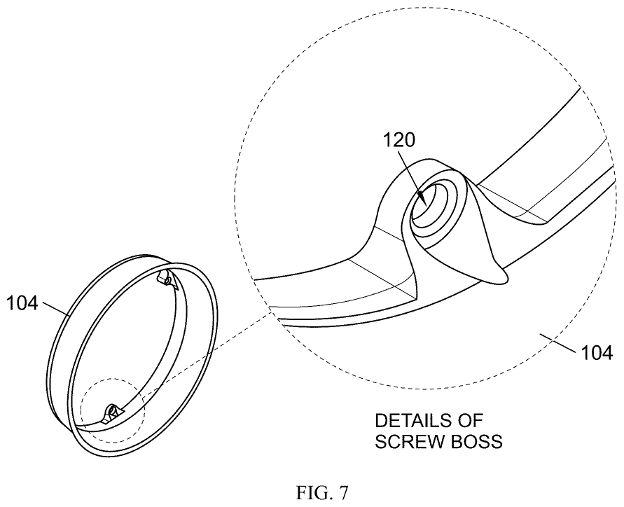

FIG. 7 is a close up of a thrust ring 104 having an attachment opening 120.

Ribs 114 to which thrust rings 104 are attached may be extensions of conventional or separate ribs or components that serve only to anchor thrust rings 104, without also connecting inner hub 110 to outer hub 112. However, from a fluid flow and manufacturing standpoint, extending conventionally designed ribs may be optimum.

In addition to interchangeable flared thrust rings, cylindrical or closed thrust rings may be included. A closed thrust ring may be used, for example, on a propeller installed on an electric motor. A cylindrical thrust ring, as used here is one of constant diameter throughout the axial length of the thrust ring. The cylindrical thrust ring may be used to lengthen the hub to achieve desired characteristics. An additional thrust ring, such as an inwardly or outwardly flared thrust ring or a closed thrust ring may be attached aft of the cylindrical thrust ring. Multiple cylindrical thrust rings may be attached to the hub to achieve a desired length increase, and therefore, attain performance objectives.

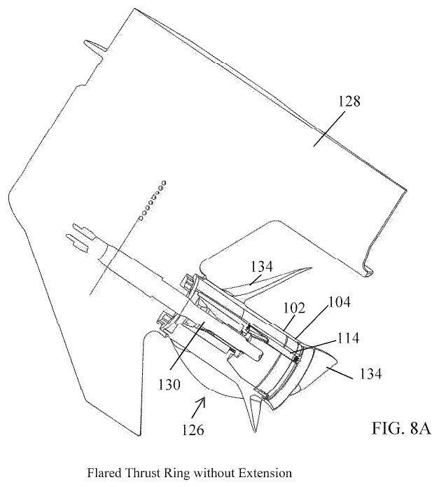

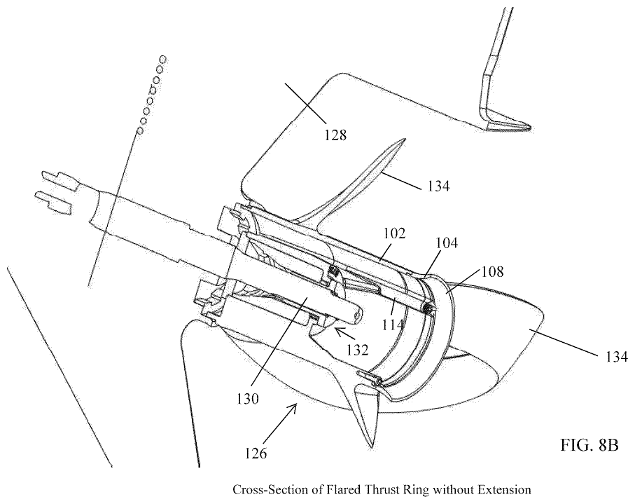

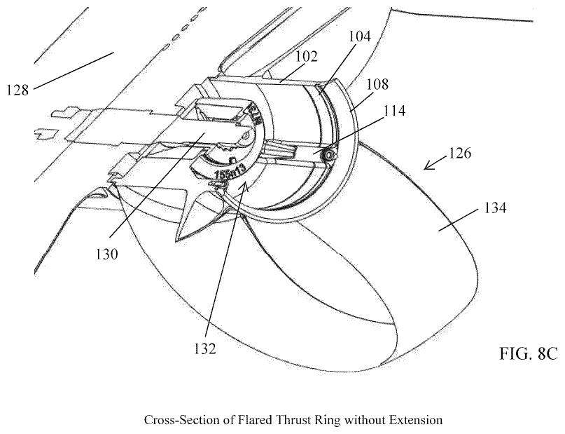

FIGS. 8A-C depict cross sectional views of a propeller 126 having blades 134, attached to an engine 128. A thrust ring 104 is shown at the aft end of propeller hub 102. Thrust ring 104 is attached to hub 102 at rib 114. Shaft 130 extends into gear housing 132 within hub 102.

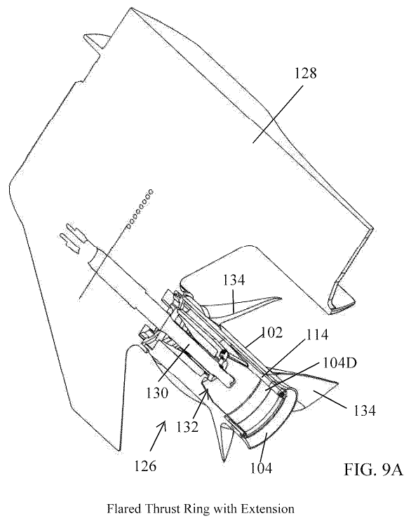

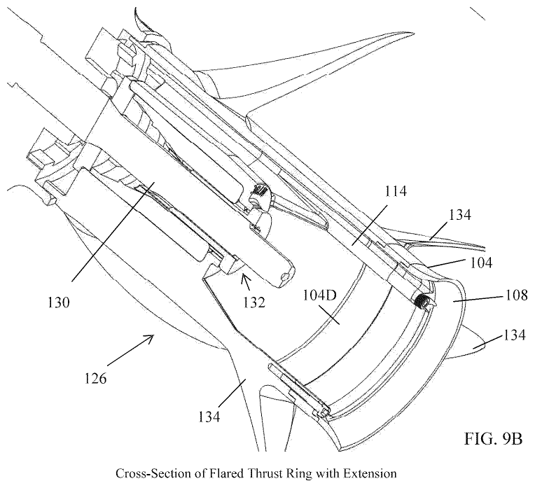

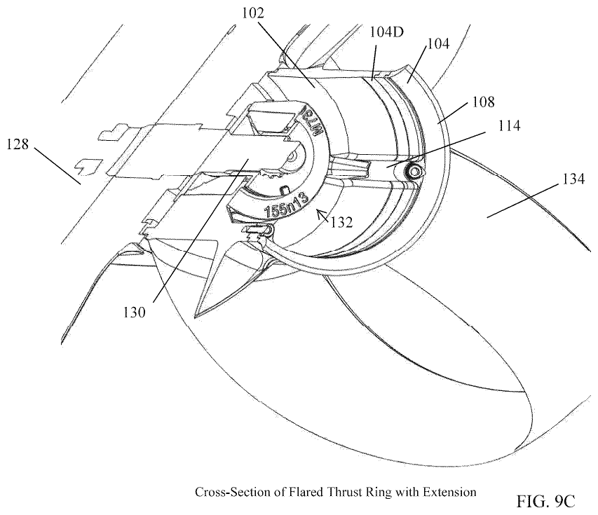

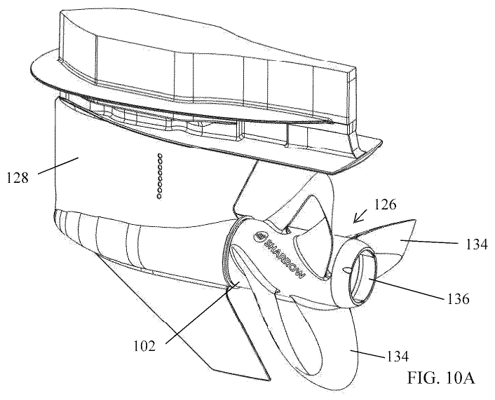

FIGS. 9A-C depict cross sectional views of a propeller 126 having blades 134, attached to an engine 128. A flared thrust ring 104 is shown attached to a cylindrical thrust ring 104D at the aft end of propeller hub 102. Cylindrical thrust ring 104D is attached to hub 102 at rib 114. Shaft 130 extends into gear housing 132 within hub 102.

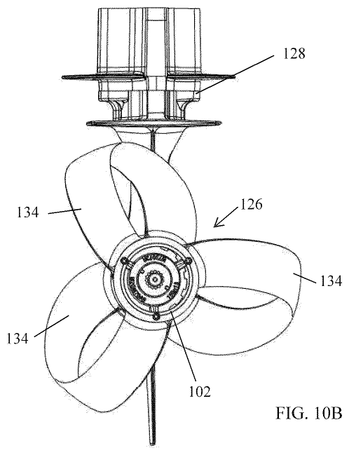

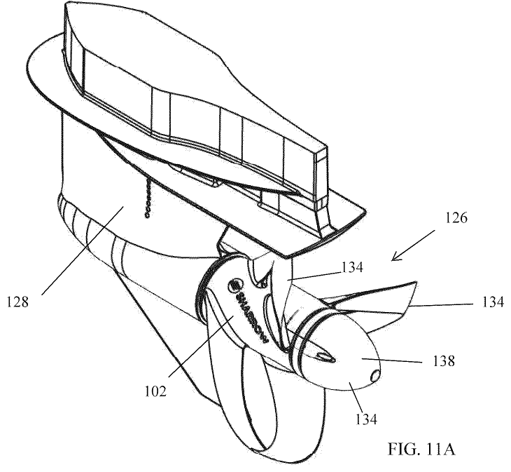

FIGS. 10A-B depict an illustrative inwardly flared thrust ring 136 on a propeller 126. FIG. 10A is a perspective view. FIG. 10B is an aft view. Propeller 126 is attached to an engine 128. In an inwardly flared thrust ring the diameter of the aft end of the extension does not increase but decreases. The smaller diameter at the aft end of the hub and thrust ring combination may provide a more favorably faired hydrodynamic flow from the hub body and blades to the aftward wake of the propeller.

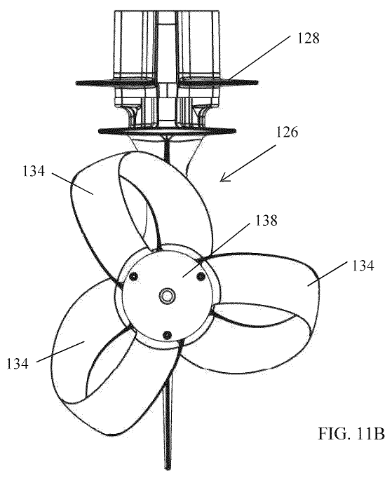

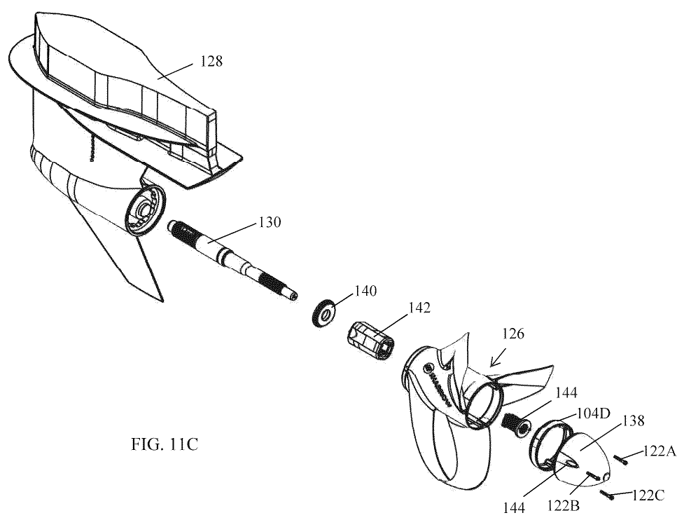

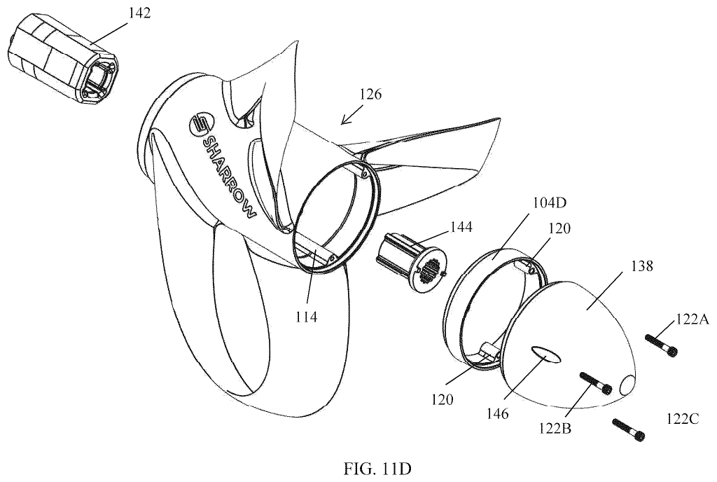

FIGS. 11A-E depicts an illustrative closed thrust ring 138. As used herein, a “closed thrust ring,” is thrust ring that completely closes the exhaust gas channel of the through hub exhaust propeller. This may provide a more fully streamlined faired “hub boss cap.” A more streamlined faired hub boss cap is known to improve efficiency. Applications exist in the electric boat market in which conventional outboard gear housing drive trains are used with electric motors, but no exhaust gas is present.

FIG. 11C depicts an exploded view of an engine 128 with a propeller 126 having a closed thrust ring 138. However, the components apply also to other thrust rings, such as cylindrical, outwardly flared and inwardly flared thrust rings. Shaft 130 is attached to engine 128 via gear housing 132. A thrust washer 140 is disposed between a hub insert 142 and gear housing 132. Hub insert 142 provides an interface between inner hub 102 and engine 128. A nut 144 secures propeller 126 to engine 128. Cylindrical thrust ring 104D is attached to propeller 126. Closed thrust ring 138 is attached to cylindrical thrust ring 104D by bolts 122A-C. Bolts 122A-C are passed through openings 146A-C in closed thrust ring 138 and through attachment openings 120A-C in thrust ring 104D. Attachment openings 120A-C are cylindrical tubes in this embodiment. Bolts 122A-C are then attached to propeller 126 at ribs 114A-C. FIG. 11D in an enlargement of a portion of FIG. 11C. FIG. 11E is a cross section of a propeller 126 attached to an engine 128, wherein propeller 126 has a closed thrust ring 138.

In illustrative embodiments of the thrust ring system, the number of ribs 114 is equal to the number of blades 134 on the propeller 126. Illustrative numbers of blades and ribs include, for example, three, four or more.

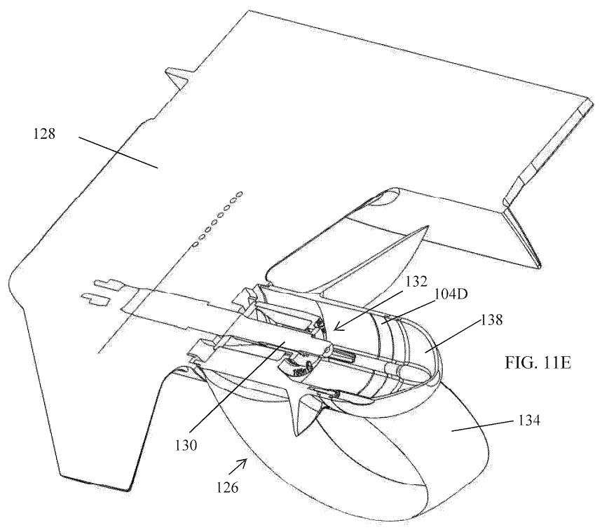

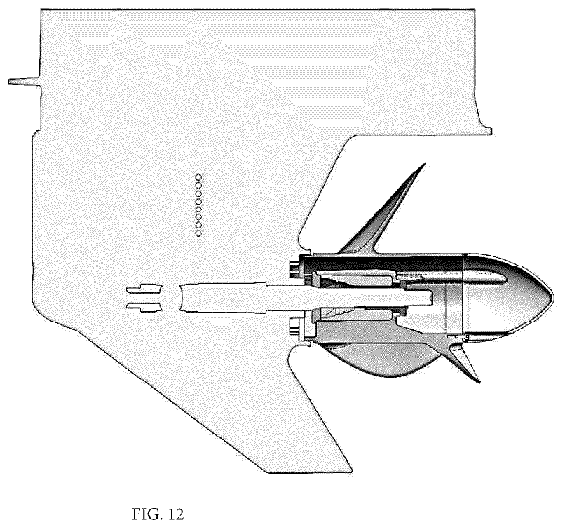

FIGS. 12 and 13 provide additional views of embodiments of a propeller with a thrust ring attached, and a modular thrust rings system. FIG. 12 is a cross-sectional view of a propeller with a thrust ring attached. FIG. 13 is a schematic of a hub with modular thrust rings and a close up of a connection mechanism to attach a thrust ring to a hub.

Thrust ring configurations may include not only the straight and flared increased diameter versions, but also reduced diameter and entirely closed versions.

Further disclosed is a method of forming a propeller that includes selecting an effective pitch amount and creating a thrust ring to produce the pitch amount for a selected propeller. The selected pitch amount may be based, for example, on selected top speed and selected acceleration. In a further embodiment, the pitch amount is based on RPM of the propeller and a selected top speed. 37. The method may further include defining a plurality of propeller blade parameter sections by selecting parameters including one or more of the following: skew angle, roll angle, rake, radius, pitch angle, vertical angle value, and extrapolating between parameter sections to form smooth lines to form a blade configured to form a loop when attached to a hub or other propeller shape. The method may further include selecting a hub diameter and length and selecting blade root positions on the hub, wherein the selected diameter and positions optimize selected performance parameters of the propeller.

These methods may be applied to conventional propellers and also to loop propellers.

Illustrative ranges of parameters include from 25% less to 25% more than specified herein. A further illustrative range is from 20% less to 20% more than specified herein. A further illustrative range is from 15% less to 15% more than specified herein. A further illustrative range is from 10% less to 10% more than specified herein.

Within the present disclosure, illustrative embodiments of thrust rings are defined, for example, in addition to a straight extension portion. For purposes of description, core dimensions of a thrust ring include: axial length, maximum OD (outer diameter), and flair radius.

The axial length is illustratively defined along the axial direction, coincident with the axial direction of the hub. The maximum OD is illustratively defined as the maximum outwardly extending diameter, and effectively the largest outer extent, and generally refers to a concentric ring, although equivalence may exist for this dimension. The flair radius is illustratively defined as the rate of curvature between the inner and outer diameter, generally also traversing some portion of the axial direction. The straight extension is by definition cylindrical, having zero flair radius. The maximum OD illustratively equals the hub OD in the illustrative embodiment of the straight extension.

For configurations of a thrust ring, the proportional magnitude of the axial length, maximum diameter and the radius of curvature of the flair can all interact as a system to induce a net influence on the pressure distributions arising in the fluid flow, which in turn influences pressures present at the thrust generating surfaces of the propeller. The magnitude and extent of the regions of pressure change influence can be proportional to the core dimensions of the thrust ring.

In the illustrative embodiment, each manner of thrust ring can be applied independently or in series with the straight extension. When a thrust ring is used in conjunction with a straight extension, the effectively axial dimension of the thrust ring is increased, thereby displacing the region of pressure change influence from the thrust ring further aft downstream of the propeller blades. This aftward location of the pressure change region can alter the resulting pressure change influence upon the thrust producing surfaces of the propeller.

An Influence Factor (IF) is defined as a scalar value that is the dimensional ratio of the product of the thrust ring axial length (Lₐ) and maximum OD (ODₘ) relative to the radius of curvature of the flair (flair radius, R_{f}):

$$IF = \frac{{L}_{a} * {OD}_{m}}{{R}_{f}}$$

Within Table T1, a number of exemplary scenarios for thrust ring dimensions is shown in accordance with various aspects of the present disclosure.

TABLE T1
THRUST RING SIZE & INFLUENCE FACTOR

| Nom Hub OD 4.626″ | | | | | |
|---|---|---|---|---|---|
| | | TR | TR | | |
| | HUB | Axial | Max | TR | INFLUENCE |
| | len | Len | OD | Flair | FACTOR |
| Thrust Ring Type | (″) | (″) | (″) | Rad. | Len*OD/R |
| 0 -extension-Straight | 9.25 | 0.275 | 4.626 | — | 0.0 |
| C-Small | 9.25 | 0.438 | 4.724 | 2.118 | 4.6 |
| B-Medium | 8.86 | 0.832 | 4.961 | 2.195 | 9.3 |
| A-Large | 8.62 | 1.068 | 5.118 | 2.475 | 11.3 |

The relationship exists, for example, where an increase in maximum OD (ODₘ) concurrent with a decrease in flair radius (R_{f}) without a corresponding change in axial length (Lₐ) would produce a relatively higher and/or more concentrated pressure in a smaller region (e.g., lesser surface area) of the thrust ring where the flair curvature is tightest, and will beat a greater distance from the affected thrust producing surfaces of the propeller. The inverse case would also apply. Thus, the selection of thrust ring configuration and/or utilization of straight extensions can permit the variable adjustment and/or tuning of propeller performance.

Within Table T2, a number of exemplary scenarios for thrust ring dimensions is shown in accordance with various aspects of the present disclosure. For example, a straight extension is embodied as having an thrust ring axial length at 3% of the axial length of the hub. Such straight extensions do not have additional outer diameter or flair radius by their nature. A small thrust ring is embodied as having an thrust ring axial length at 5% of the axial length of the hub, thrust ring maximum OD at 2% greater than the hub diameter, and thrust ring flair radius at 21% of the hub diameter. Medium and large thrust rings within Table T2 are dimensioned accordingly.

TABLE T2
THRUST RING SIZE & INFLUENCE
FACTOR as % of HUB DIMENSIONS

| | HUB | TR axial | TR Max | TR Flair |
|---|---|---|---|---|
| | length | length as | OD % | Radius |
| | inch | % of Hub | Incr of | as % of |
| | (″) | Length | Hub Diam | Hub Diam |
| 0 -extension-Straight | 9.25 | 3% | — | — |
| C-Small | 9.25 | 5% | 2% | 21% |
| B-Medium | 8.86 | 9% | 7% | 38% |
| A-Large | 8.62 | 12% | 11% | 43% |

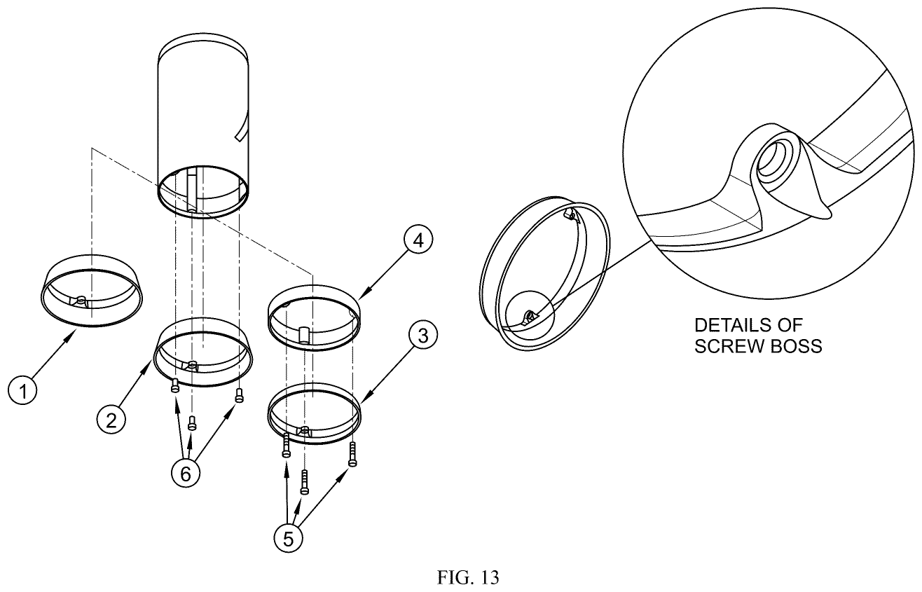

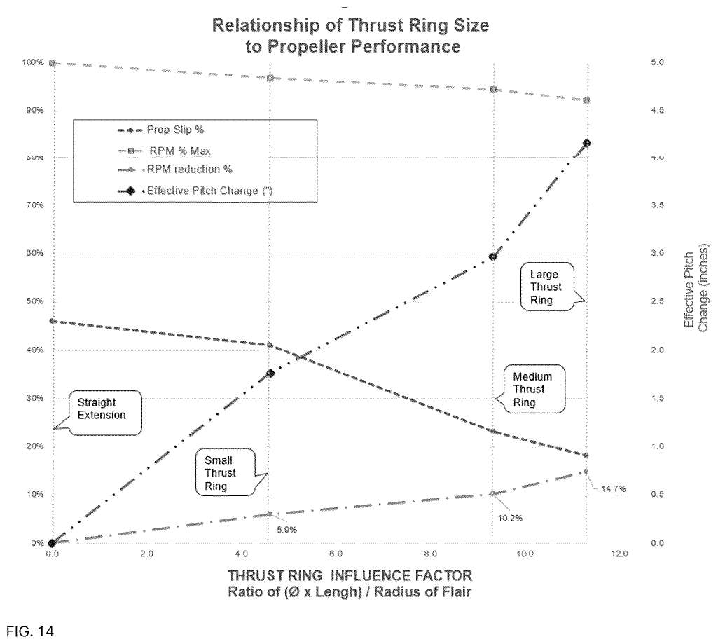

With reference to FIG. 14, a graph depicts the differences in effective pitch increase compared with RPM and Influence Factor (IF). The effective pitch increase is illustratively defined as the amount of blade pitch experienced according to actual amount of forward movement produced by the propeller (on the assembly or the vessel itself) per turn of the propeller, e.g., as a geometric linear dimension in the direction of motion (e.g., travel). Effective pitch is as opposed to actual or mechanical pitch as the idealized amount of forward movement, such as an ideal wood screw driving into wood. Generally, the effective pitch is increasing proportionally as the Influence Factor (IF) increases. Propeller slip is defined as the amount of “lost” forward effort, such that the difference between mechanical pitch and effective pitch can amount to propeller slip.

In general within the illustrative embodiments, it can be observed that as thrust ring size increases (I.F. Increases) thrust produced increases, allowing the same (forward) speed to be achieved at a lower rpm. This can establish the following conditions for the case of going from a generally smaller diffuser to a generally larger diffuser:
prop slip decreases
advance rate increases
effective pitch increases
mechanical pitch remains unchanged
if speed is held constant, the rpm needed to achieve that speed decreases
if rpm is held constant, the vessel can travel faster

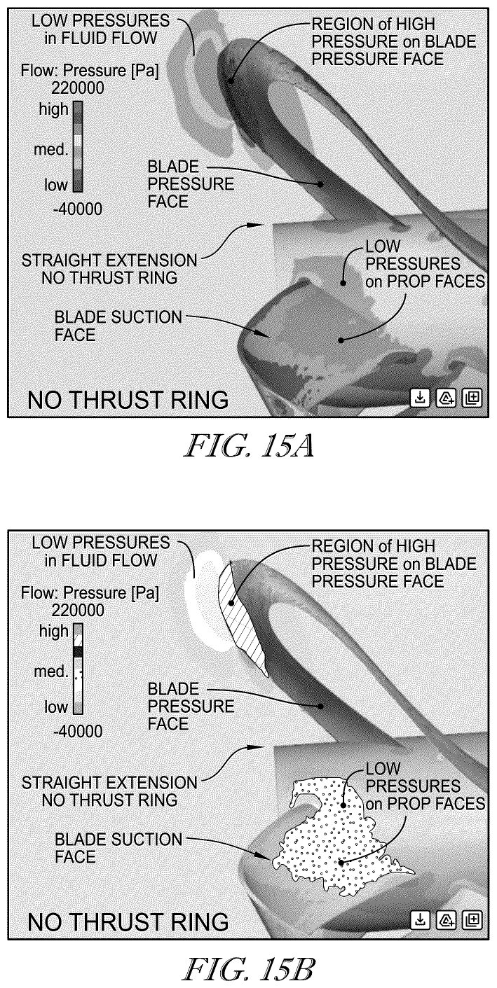

Referring to FIGS. 15 and 16, comparison between a propeller assembly having no thrust ring (FIGS. 15A&B) and an assembly having a medium sized thrust ring (FIGS. 16A&B) can be observed. For example, high pressure areas of the propeller in FIG. 15 are observed as more or less isolated to the blade pressure face nearest the tip. By comparison in FIG. 16, the thrust ring can be observed to generate larger regions of high pressure that extend inward along the blade pressure face towards the hub, as well as elevating the pressures on the blade low pressure faces.

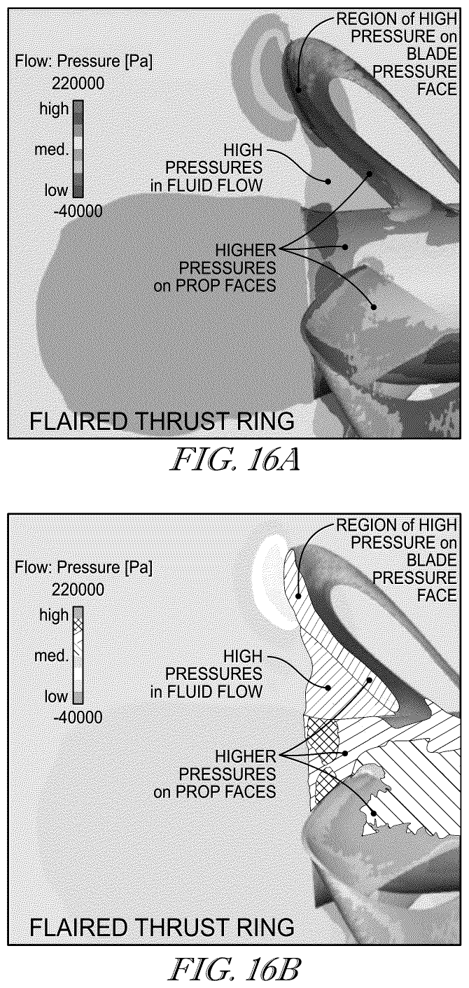

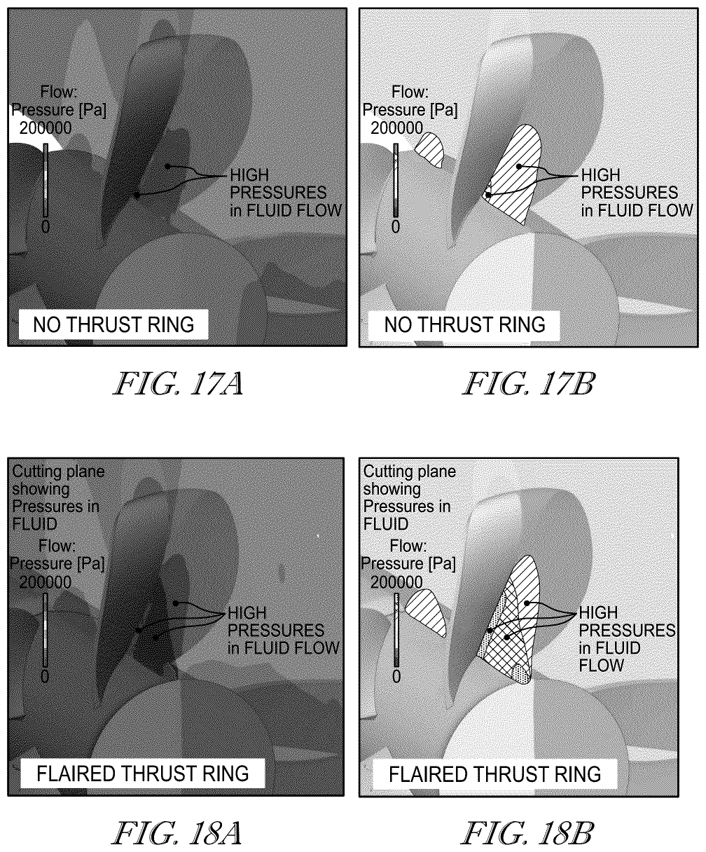

Referring to FIGS. 17 and 18, comparison between a propeller assembly having no thrust ring (FIGS. 17A&B) and an assembly having a medium sized thrust ring (FIGS. 18A&B). These images depict the pressures present in the fluid mapped to a vertical cutting plane for the purposes of visualization. Shown is an illustrative example of pressure increases in the fluid induced by the presence of the thrust ring, wherein (FIG. 18) shows higher pressures over a larger volume of fluid than the instance shown in (FIG. 17) without a thrust ring.

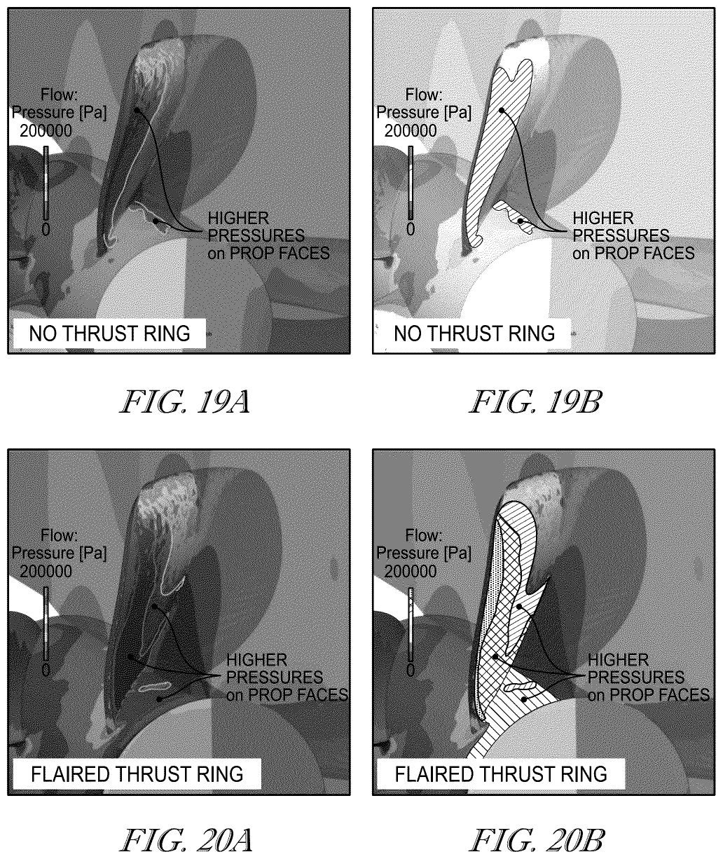

Referring to FIGS. 19 and 20, comparison between a propeller assembly having no thrust ring (FIGS. 19A&B) and an assembly having a medium sized thrust ring (FIGS. 20A&B). These images depict the pressures present at the blade and hub surfaces for the purposes of visualization. Shown is an illustrative example of pressure increases in the fluid induced by the presence of the thrust ring, wherein (FIG. 20) shows higher pressures over a larger surface area of blade pressure face than the instance shown in (FIG. 19) without a thrust ring.

Various embodiments of the discloses innovation have been described, each having combination of elements. The disclosure is not limited to the specific embodiments disclosed, and may include different combinations of the elements disclosed or omission of some elements and the equivalents of such structures. While the invention has been described by illustrative embodiments, additional advantages and modifications will occur to those skilled in the art. Therefore, the invention in its broader aspects is not limited to specific details shown and described herein. Modifications, for example but without limitation, to the number of blades and curvature of the blades, may be made without departing from the spirit and scope of the invention. Accordingly, it is intended that the disclosure not be limited to the specific illustrative embodiments, but be interpreted within the full scope of the appended claims and their equivalents.

What is claimed is:

1. A propeller assembly, comprising:
a propeller drive assembly including a propeller hub, and at least one blade engaged with the hub and projecting radially outward therefrom, the at least one blade defining a looped-shape, the propeller hub adapted for driven rotation to rotate the at least one blade to generate fluid thrust; and
an thrust ring kit comprising a plurality of thrust rings, each thrust ring individually selectable for tuning of propeller drive performance, each one of the plurality of thrust rings configured for connection with the propeller hub of the propeller drive assembly as an aftward extension from the propeller hub for configuring thrust forces generated under operation of the propeller drive assembly, wherein each of the plurality of thrust rings is defined with a different combination of axial length, maximum outer diameter, and flair radius defining a unique effective pitch increase and/or slip value compared with the propeller drive assembly alone.

2. The assembly of claim 1, wherein the thrust rings vary relative to one another in axial length.

3. The assembly of claim 1, wherein the thrust rings vary relative to one another in flare radius.

4. The assembly of claim 1, wherein the thrust rings are configured to provide different performance characteristics.

5. The assembly of claim 1, wherein each thrust ring is attachable to ribs within the propeller hub.

6. The assembly of claim 5, wherein each thrust ring is configured to account for additional weight and/or material of ribs of increase length.

7. The assembly of claim 1, wherein at least one of the plurality of thrust rings has a flared aft portion with maximum outer diameter within the range from 90% to 125% of the outer diameter of the hub.

8. The assembly of claim 7, wherein the maximum outer diameter of the flared aft portion of the at least one thrust ring is within the range from 100% to 125% of the outer diameter of hub.

9. The assembly of claim 1, wherein at least one of the plurality of thrust rings has a flared aft portion, wherein the maximum outer diameter of the flared aft portion is within the range from 1% to 50% of the length of the hub.

10. The assembly of claim 9, wherein the maximum outer diameter of the flared aft portion is within the range from 10% to 40% of the length of the hub.

11. The assembly of claim 9, wherein the maximum outer diameter of the flared aft portion is within the range from 15% to 35% of the length of the hub.

12. The assembly of claim 1, wherein an axial length of at least one of the thrust rings is within the range from 5% to 25% of the outer diameter of the hub.

13. The assembly of claim 12, wherein the axial length is within the range from 10% to 15% of the outer diameter of the hub.

14. The assembly of claim 1, wherein at least one of the thrust rings is configured to modify RPM within the range from −350 to 100 to increase effective pitch by an amount within the range from 1″ to 3″.

15. The assembly of claim 1, wherein at least one of the thrust rings is configured to modify RPM within the range from −400 to 150 to increase effective pitch by an amount within the range from 1″ to 5″.

16. The assembly of claim 1, wherein the thrust rings are configured to be attachable to a loop-propeller.

17. A method of forming a propeller assembly, the method comprising:
providing a propeller having a propeller hub;
selecting a pitch amount; and
providing a thrust ring to produce the pitch amount for the propeller.

18. The method of claim 17, wherein providing the thrust ring includes selecting a thrust ring from a thrust ring kit comprising a plurality of thrust rings, each thrust ring individually selectable for tuning of propeller drive performance, each one of the plurality of thrust rings configured for connection with the propeller hub of the propeller drive assembly as an aftward extension from the propeller hub for configuring thrust forces generated under operation of the propeller drive assembly, wherein each of the plurality of thrust rings is defined with a different combination of axial length, maximum outer diameter, and flair radius defining a unique effective pitch increase and/or slip value than without the thrust ring.
